(19) United States
(12) Patent Application Publication
(10) Pub. No.: US 2026/0210186 A1
(43) Pub. Date: Jul. 23, 2026

(54) REAL TIME INTERACTIVE GEOSTEERING USING VIRTUAL REALITY

(71) Applicant: Halliburton Energy Services, Inc., Houston, TX (US)

(72) Inventors: Hsu-Hsiang Wu, Houston, TX (US); Dagang Wu, Houston, TX (US); Ivan Efimov, Houston, TX (US)

(21) Appl. No.: 19/035,613

(22) Filed: Jan. 23, 2025

(51) Int. Cl. E21B 7/04; E21B 49/00; G06F 3/01

(52) U.S. Cl. CPC E21B 7/04; E21B 49/00; E21B 2200/20; G06F 3/011

(57) ABSTRACT

Examples of a method, system, and control system are disclosed herein. In one embodiment, a method comprises obtaining real time measurement data of a subsurface formation while drilling one or more wellbores into the subsurface formation; performing inversions of the measurement data to transform the measurement data into physical geology representations surrounding the one or more wellbores; communicating the measurement data and physical geology representations with two or more users, the two or more users including at least one remote user equipped with virtual reality (VR) equipment configured for interactive viewing of the measurement data and geology representations in real time and interactive control of drilling operations at the one or more wellbores; receive inputs from the two or more users; and adjusting at least one drilling parameter in at least one wellbore during drilling operations in response to the inputs from at the at least one remote user.

### FIELD OF THE INVENTION

The disclosure generally relates to directional drilling and, in particular, an interactive system for directing drilling operations for drilling a wellbore through a subsurface formation.

### BACKGROUND

In real time geosteering operations, the location of bed and/or fluid boundaries may be critical information when steering a drill bit through a subsurface formation. Geosteering engineers may steer a drill bit along a path to drill a wellbore in a target formation to avoid penetrating adjacent formations. Measurements obtained from various sensors on a downhole assembly, such as, for example, logging while drilling (LWD) and measuring while drilling (MWD) sensors provide downhole drilling data determine various features and obstacles in the formation. Visualization of downhole data has been available in both two-dimensional and three-dimensional displays. However, interactivity between operators located at the wellbore, remote operators, and additional remote decision makers has heretofore been unavailable. What is needed is a system that provides both visualization, communication, and manipulation of the downhole data and/or adjustment of wellbore operations in response to the wellbore data in real time.

### BRIEF DESCRIPTION OF THE DRAWINGS

Implementations of the disclosure may be better understood by referencing the accompanying drawings.

FIG. 1 is a schematic depicting an example well system, according to some implementations.

FIG. 2 is a wellbore system, according to some implementations.

FIG. 3 is a wellbore system incorporating virtual reality interfaced users, according to some implementations.

FIG. 4 is a flowchart depicting a method, according to some implementations.

FIG. 5 is a block diagram depicting an example computer, according to some implementations.

### DETAILED DESCRIPTION

The description that follows includes example systems, methods, techniques, and program flows that embody aspects of the disclosure. However, this disclosure may be practiced without these specific details. For instance, this disclosure refers to resistivity measurements. Aspects of this disclosure may also be applied to any other measurements. For clarity, some well-known details and techniques may be omitted.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

In the following description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Unless otherwise specified, any use of any form of the term “couple,” or any other term describing an interaction between elements is not meant to limit the interaction to direct interaction between the elements and also may include indirect interaction between the elements described.

The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder.

Geosteering operations may involve identifying geological features (such as formation bed boundaries, faults, etc.) while drilling a wellbore in a subsurface formation. Formation property measurements (such as electromagnetic (EM) measurements) may be obtained from LWD and MWD tools and transformed, via an inversion process, into visualizations of the geological features surrounding the wellbore.

Completing a wellbore based on various requirements and measurements has been always a challenging and time-consuming task. It requires the involvement of multiple subject matter experts (SMEs) across different disciplines to deliberate on the essential objectives and real time data for optimizing reservoir development and/or ensuring the safe completion of the well. To effectively communicate goals and decision-making information to team members, it is beneficial to have a team located at or near the wellsite. However, this can lead to high costs due to labor expenses and the need to maintain duplicate resources globally. The present disclosure provides a solution to the foregoing challenges and in addition provides improvements to drilling decision making in real time.

A cloud-based centralized database, integrated with virtual reality (VR) technology, can significantly enhance communication efficiency. Utilizing a cloud-based centralized database in conjunction with VR technology can greatly improve communication and collaboration efficiency. With three-dimensional (3D) VR capability, users across the globe can effectively communicate their individual perspectives and engage in interactive discussions through immersive, multi-window visualizations. Additionally, the cloud-based decision-making environment reduces the need for on-site teams, leading to a reduction in required resources.

Previous VR systems have provided simply viewing controlling and manipulation of data and downhole operations for and provide suggestions for future decisions and operations, but the existing VR systems do not provide interaction or collaboration in real time and do not provide for direct interactive control of downhole tools at the wellbore from remote users. Solutions provided herein disclose VR equipment and systems configured for interactive viewing of real time data and interactive control with wellbore controls and downhole drilling equipment.

In one embodiment, a system for use with one or more wellbores includes sensors placed downhole in the one or more wellbores and configured to obtain real time measurement data while drilling the one or more wellbores in a subsurface formation; and a control system. The control system includes at least one processor and at least one non-transitory computer-readable medium having instructions stored thereon that are executable by the processor. The instructions include instructions to obtain the measurement data of the subsurface formation from the sensors while drilling the wellbore in the subsurface formation; and instructions to perform inversions of the measurement data to transform the measurement data into physical geology representations surrounding the one or more wellbores. Even though the measurements are acquired at wellbore positions, the measurements have various detection range into the formations from the wellbore where the measurements are taken. The inversion then aims to determine and invert what possible formation geological models surrounding the wellbore that possibly can simulate mimic tool responses matching with the measurements. The inversions may be one-dimensional (1D), two-dimensional (2D), or three-dimensional (3D), and in some embodiments four-dimensional (4D) and may be performed in some examples, in a cloud database and/or virtual computing machines connected with the cloud database. Likewise, the geology representations may be 3D. The instructions further include instructions to communicate the geology representations to two or more users. The two or more users include at least one remote user equipped with virtual reality (VR) equipment configured for interactive viewing of the geology representations in real time and interactive control of drilling operations at the one or more wellbores. The instructions further include instructions to receive inputs from the two or more users; and instructions to adjust at least one drilling parameter in at least one wellbore during drilling operations based on the inputs from the at least one remote user. The at least one remote user with VR equipment may directly interact with the control system and directly interact with downhole tools at the one or more wellbores.

The system described herein provides real time interaction and collaboration among multiple users. Multiple users at different locations around the world may interact with each other and with the wellbore controls to make changes and adjustments in real time to downhole drilling operations, including real time manipulation/control of downhole tools to adjust drilling direction and other drilling parameters. “Real-time,” in this context, refers to acquiring measurements during the drilling process. These measurements are transmitted immediately (or with minimal delay) via telemetry to the surface, enabling operators to make timely and informed decisions about the wellbore trajectory or other critical adjustments during drilling. The key advantage of real-time data is its ability to support dynamic wellbore steering and operational optimization, ensuring that decisions are based on the most current and accurate information available.

“Post-run” or “memory” refers to measurements that are recorded internally within the tool during drilling and are only accessible after the drilling operation is completed. These measurements are retrieved once the tool is removed from the wellbore. Unlike real-time data, post-run or memory data cannot influence the immediate drilling process or wellbore steering. Instead, this data is typically used for post-analysis, verification, or to enhance the understanding of the wellbore environment and formation characteristics after drilling has concluded.

Solutions and technical improvements provided by the present disclosure include remote users equipped with a VR system for interaction based on at least 3D visualization of multiple windows; providing information of downhole inversion results, drilling parameters, a variety of tools'measurements, geosteering decisions, pre-well modeling results, and various other wellbore and drilling parameters. The disclosed solution also provides real time access with the VR equipment to wellsite information, which may be in a cloud database, and at least 3D visualization and 3D inversion database from one or more wellbores, including real time data from offset wells. The VR equipment for the remote users is equipped with real time interactive controls, such as real time hand/manual control interactions with video and audio. In addition to wellbore controls, the system and methods described herein also provides VR decision-based interactions; VR uncertainty visualizations; and real time pre-well modeling to estimate drilling performance at future planned depth range and evaluate possible uncertainty of existing depth range and future depth ranges.

As a result of remote user interaction with wellbore controls and better visualization of drilling data, less personnel may be needed or involved with multiple jobs ongoing than previously required. Instead the current solution provides a cloud-based and real time interactive decision-making system that enables direction downhole tool automation in drilling and geosteering applications from multiple users at multiple locations.

While there are numerous VR products available in other industries, disclosed herein are advanced technologies that explore and evaluate earth formations in greater detail, offer higher resolution imaging near wellbores, and give improved automaton decisions downhole. By integrating VR technology with real time and high-quality measurements from these downhole technologies, the provided solutions enhance communication with operations and make informed geosteering decisions to improve wellbore drilling, placement and reservoir management. The interactive visualization provided by the methods and systems herein may also provide improved modelling capabilities for current and future wellbores.

### Example System

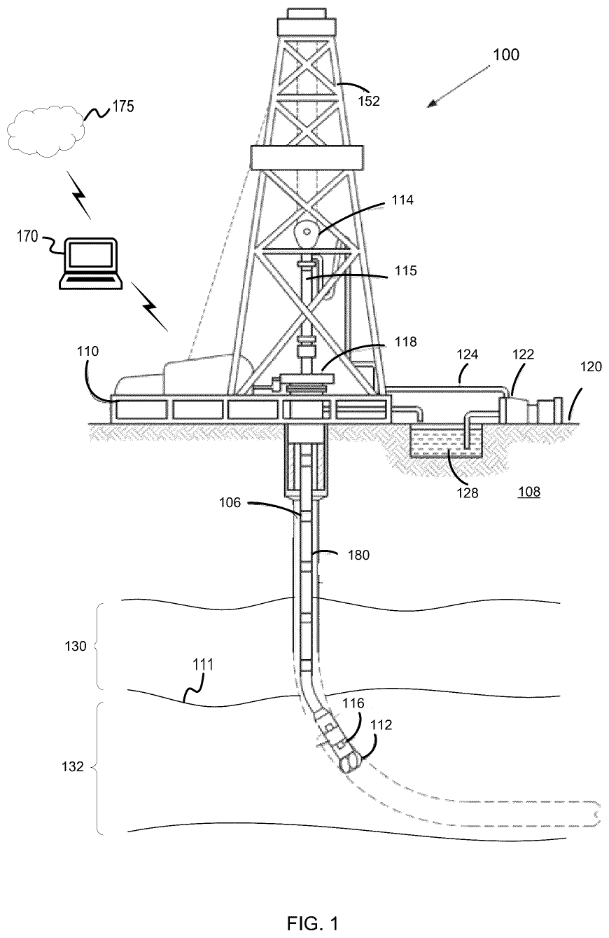

FIG. 1 is a schematic depicting an example well system, according to some implementations. In particular, FIG. 1 is a schematic diagram of a well system 100 that includes a drill string 180 having a drill bit 112 disposed in a wellbore 106 for drilling the wellbore 106 in the subsurface formation 108. While depicted for a land-based well system, example implementations may be used in subsea operations that employ offshore floating or sea-based platforms and rigs.

The well system 100 may further include a drilling platform 110 that supports a derrick 152 having a traveling block 114 for raising and lowering the drill string 180.

The drill string 180 may include, but is not limited to, drill pipe, drill collars, and drilling assembly 116. The drilling assembly 116 may comprise any of a number of different types of tools including a rotary steerable system (RSS), measurement while drilling (MWD) tools, logging while drilling (LWD) tools, mud motors, etc. A kelly 115 may support the drill string 180 as it may be lowered through a rotary table 118. The drill bit 112 may include roller cone bits, polycrystalline diamond compact (PDC) bits, natural diamond bits, any hole openers, reamers, coring bits, and the like. Drilling parameters of drilling the wellbore 106 may be adjusted to increase, decrease, and/or maintain the rate of penetration (ROP) of the drill bit 112 through the subsurface formation 108 and steer the drill bit 112 through the subsurface formation 108. The subsurface formation 108 may include multiple formations such as formations 130, 132. The interface between the formations 130 and 132 may be the formation bed boundary 111. The drilling parameters may assist in steering the wellbore 106 to avoid contact and/or penetration of the formation bed boundary 111. Drilling parameters may include weight-on-bit (WOB) and rotations-per-minute (RPM) of the drill string 180. A pump 122 may circulate drilling fluid through a feed pipe 124 to the kelly 116, downhole through the interior of the drill string 180, through orifices in the drill bit 112, back to the surface 120 via an annulus surrounding the drill string 180, and into a retention pit 128.

In some implementations, various sections of the wellbore 106 such as the vertical, tangent, curve, and horizontal sections may require directional drilling to steer the drill bit 112 on a planned well path and/or keep the wellbore 106 in a target formation. Sensors on the drilling assembly 116, such as gamma ray sensors, porosity sensors, electromagnetic sensors, etc., may log respective measurement data in real time while drilling the wellbore 106. The real time data measurements may be obtained from the sensors on the drilling assembly 116 and uplinked to the surface 120. In some implementations, the real time measurement data may be communicated to tools on the drilling assembly 116 for processing and also to one or more remote databases or processors, such as a cloud database 175, which may also connect with one or more virtual computing machines. The measurement data may be processed and utilized to determine the location of the formation bed boundary 111. Steering decisions may be determined based on the wellbore 106 location relative to the formation bed boundary 111 and may be communicated back to the drilling assembly 116 for implementation to maintain the planned well path and/or remain in the target formation. For example, a target formation of the wellbore 106 may be formation 132. Steering decisions may be implemented such that the wellbore 106 may not be drilled through the formation bed boundary 111 and into formation 130.

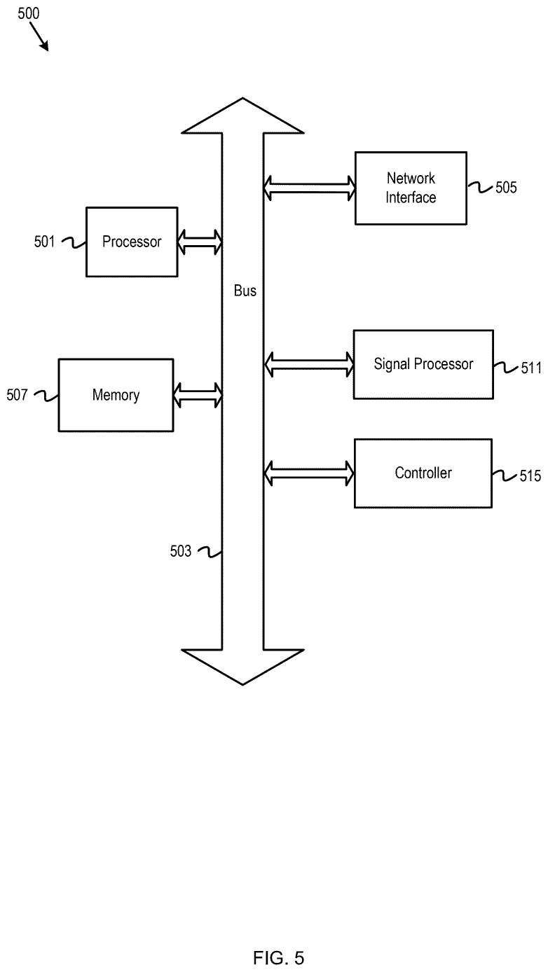

The well system 100 includes a computer 170 that may be communicatively coupled to other parts of the well system 100, one or more additional wellbores, and remote processors, such as the cloud database 175 and virtual computing machines, as well as remote users. In the embodiments disclosed herein, the remote users may be equipped with virtual reality (VR) equipment configured for direct communication and interaction with the well system and tools of the drilling assembly 116. The computer 170 may be local or remote to the drilling platform 110. A processor of the computer 170 may control drilling operations of the well system 100 or subsequent drilling operations of other wellbores, as well as receive inputs and commands from the one or more remote users having VR equipment and connected through the cloud database. An example of the computer 170 is depicted in FIG. 5, which is further described below.

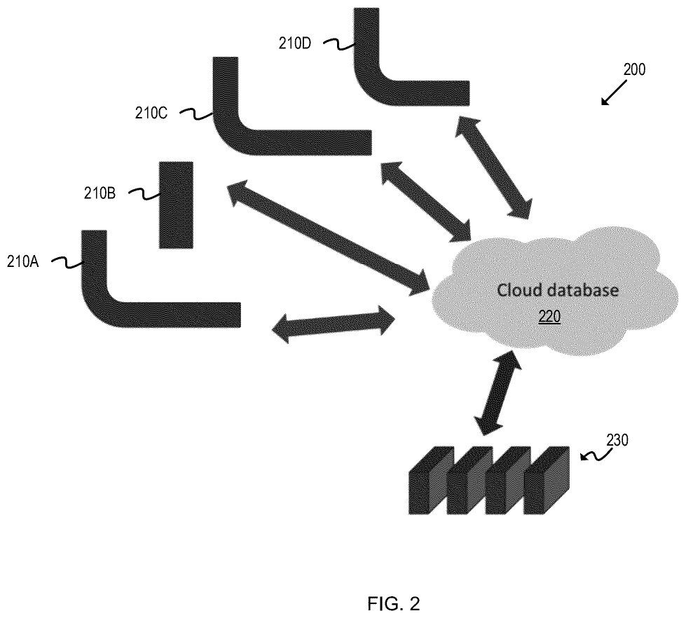

FIG. 2 illustrates an interactive system 200 that may be used with one or more well sites 210A-210D, where each well site may be similar to well system 100. The well sites 210A-210D may be at a same or different locations, and may be any type of wellbore, including vertical and horizontal and a combination thereof. Currently, the management for each of the well sites 210A-210D may be managed locally, with real time measurements transmitted from downhole to individual well sites. The data may then be stored in local machines, such as one or more computers at each well site 210A-210D (such as computer 170), or in a cloud database 220, processed using advanced algorithms either locally or in virtual computing machines 230 connected with the cloud database 220, and subsequently transmitted back to the local well sites 210A-210D. Real time decisions are made at each well site based on discussions among various crews and customers locally. However, this approach is not highly efficient, and local operators may make poor decisions because of a lack of training or experience. Furthermore, abnormal datasets may arise in one well that the local team may not have encountered before. The system 200 may include remote users connected with one or more of each well-site 210, cloud database 220 and virtual computing machines 230. While these remote users may be able to access the data, currently the remote users must rely on existing communication and data sharing methods such as phone calls, IP phones, and online screen sharing and calling platforms (such as, for example, TEAMS® and WeChat®). These current methods are not a practical solution for effective communication and collaboration, nor do these current communication and collaboration methods provide for remote users to interact directly with wellbore controls at each of the wellbores 210A-210D. Local crews at each well site are still required and still play an indispensable role in achieving efficient well drilling and reservoir management.

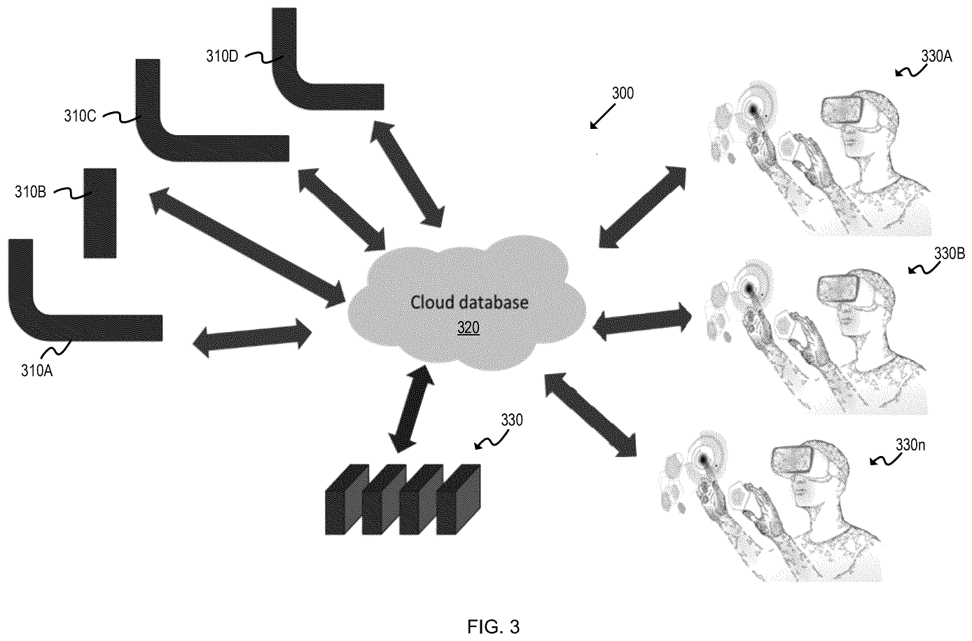

FIG. 3 illustrates an improved interactive system 300 that incorporates virtual reality (VR) equipment into the system 300 for improved real time interaction and manipulation of the downhole tools for improved drilling and geosteering operations downhole. The system 300 similarly includes one or more well sites 310A-310D which may each have a computer or controller (such as computer 170) and be connected with a cloud database 320. Real time data from the one or more well sites 310A-310D may be stored onsite and in cloud database 320 and may be processed using advanced algorithms either at local computing resources, in the cloud database 320 or in virtual computing machines 330 connected with the cloud database.

System 300 also includes at least one remote user 340A having an interactive VR system, and in some examples may include a plurality of additional remote users 340B, ... up to 340 (a plurality of additional “n” number of remote users). The number of users will depend on how many projects/wellbores the user is getting involved with, and also depending on how many downhole tools/measurements are available and how many drilling parameters need to be adjusted. Each of the remote users 340 may all have interactive VR equipment and/or systems for interacting with the data and processed data from the well sites, cloud database 320, and computing machines 330. In some embodiments, and onsite user may also have VR systems for interacting with the remote users. The VR system may include multiple VR enabled equipment, including at least a viewing device, such as VR goggles; interactive controls, which may include one or manual interfaces such as keypad, joystick touchscreen, and other VR interactive devices; and a communication interface. The VR system may include both wired and wireless connections and be communicatively coupled with the cloud database 320 through which each remote user 340 may communicate with other remote users 340 and an onsite user/operator at the wellbore. In some embodiments, the VR system may also be communicatively coupled with onsite wellbore controls or processors such that at least one remote user may directly interface with wellbore controls and direct change and/or control drilling parameters from the remote location. The remote users 340 are able to direct operation of the wellbore tools and operation from any remote location. For example, if the well site is located offshore, at least one remote user is not offshore but may still be able to control drilling operations offshore. This enables better real time changes and improvements to the ongoing drilling operations rather than having to wait for instructions to be transmitted to an onsite operator for further processing.

The users, both remote and on-site want to understand predictive tool responses via modeling by adjusting the wellpath, the inverted formation models. Also, the users can further perform the inversions on these predictive tool responses (and not real tool measurements). The predictive responses can be modeled at any location surrounding the wellbore, at the wellbore or at any future wellbore locations that tools haven't penetrated. In the end, users can run inversion on the predictive responses to acquire new inverted formations, and then compare it to the inverted formations from the inversion based on the tool measurements) The real time data may include LWD and MWD measurements, gamma ray data, density images, resistivity images, resistivity logs, trajectory parameters, drilling parameters, offset logs, seismic data, geological formation models, temperatures, pressures, vibrations, etc. The real time measurement data may be inverted. The data inversions may include one-dimensional (1D) inversions, two-dimensional (2D) inversions, three-dimensional (3D) inversions. Additionally, higher-dimensional visualizations, such as integrating multiple 1D~3D inversion results over different times or depths, can also be performed. In some embodiments, the virtual computing machines 230 may be one or more remote processors, and may in some embodiments, incorporate one or more neural networks. The one or more neural networks may also incorporate trainable learning machines which may be used for further modelling or processing of the data for additional uses beyond real time interaction with drilling operations within the wellbores.

The data may include raw real time measurement data from each well site 310A-310D, processed data and data inversions from the cloud database 320 and/or virtual computing machines 330. All of the data may be collected and available in the cloud database 320. As such, the remote users 340 may be located at any location worldwide and be able to access the information simultaneously. Through integration with VR technology, multiple window visualizations of various datasets (inversion results, resistivity logs, trajectory parameters, drilling parameters, offset logs, seismic data, etc.) are made available for online discussions with remote users 340 across the globe. The 3D visualization capabilities of the VR technology allow for a more thorough viewing and detailed evaluation of certain measurements and datasets, such as predicted or proposed wellbore placement and 3D downhole imaging. Each remote user 340 may manipulate the 3D data in real time for different views, add or remove different data points or types, and view different perspectives of the data as needed. Each of the remote users 340 may make real time proposals, projections, real time modelling changes, or adjustments using VR technology linked to individual software within a single or multiple visualization windows, and other users can see these changes instantly, accept or modify them, and then compare their proposals with others based on VR visualization.

The interactive real time collaboration provided by the system 300 facilitates effective discussions and decisions by providing better visual representation for all team members to quickly understand, compare and assess all proposed decisions, and make more proactive decisions.

In some alternate examples and embodiments, the VR technology can potentially be substituted with 3D projection technology, eliminating the need for VR goggles. A user can choose to visualize multiple 2D plane at different angles relatively to the users using the viewing device. Additionally, various VR techniques and capabilities can be employed to access the cloud database 320, view data from multiple windows and angles, and engage in online discussions with other users to make adjustments and optimize wellbore placements. The final drilling decisions can then be transmitted back to individual well sites and automatically connected to downhole tools for automated drilling. Moreover, users can support multiple tasks, as all real time data and calculation results are stored in the cloud database 320, accessible from anywhere in the world.

In addition, a same remote user 340 may be able to interact with multiple well sites and multiple projects at the same time, whereas previously an SME would be required for each well site. Further, the onsite user/operator may not be as experiences and remote users may be able to work with the onsite user and provide additional technical assistance and may also provide additional training and experience.

### Example Operations

Example operations are now described.

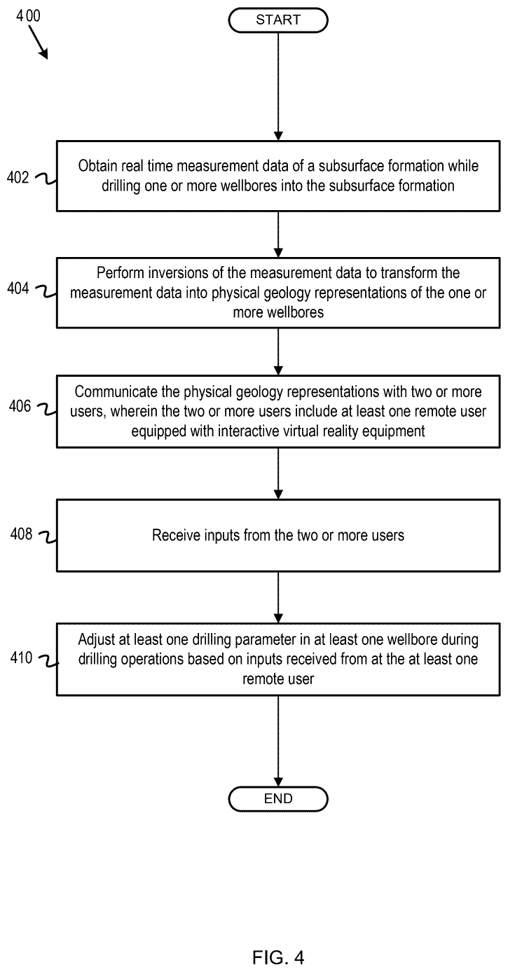

FIG. 4 is a flowchart depicting a method 300 of example operations for updating drilling operations at one or more wellbores. The method 300 begins at a block 402. At block 402, real time measurement data of a subsurface formation while drilling one or more wellbores into the subsurface formation are obtained from sensors. The sensors in the one or more wellbores may be connected with a wellbore control system for each wellbore. The wellbore control systems may be connected with a cloud database.

At a block 404, inversions of the real time measurement data are performed to transform the measurement data into physical geology representations of the one or more wellbores. In some embodiments, this may happen on one or more processors. The one or more processors may be positioned at each of the wellbores, may be in a cloud database, and in some embodiments, may be virtual machines connected with the cloud database and with the wellbores via the cloud database.

At a block 406, the physical geology representations and measurement data are communicated with two or more users, wherein the two or more users include at least one remote user equipped with virtual reality equipment configured for interactive viewing of the measurement data and geology representations in real time and interactive control of drilling operations at the one or more wellbores.

At a block 408, a controller at each wellbore is configured to receive inputs from the two or more users.

At a block 410, at least one drilling parameter may be adjusted in at least one wellbore during drilling operations in response to the inputs from the at least one remote user. As illustrated and described in FIG. 3, the one or more remote users equipped with VR equipment may be communicatively connected with each other, and with a control system at each wellbore. The remote users may be able to interact with the wellbore control systems and directly adjust drilling parameters in real time while drilling operations are ongoing in the one or more wellbores.

### Example Computer

FIG. 5 is a block diagram depicting an example computer, according to some implementations. FIG. 5 depicts a computer 500 that includes a processor 501 (possibly including multiple processors, multiple cores, multiple nodes, and/or implementing multi-threading, etc.). The computer 500 includes a storage device such as a memory 507. The memory 507 may be system memory or any one or more possible realizations of machine-readable media know to those skilled in the art.

The computer 500 also includes a bus 503 and a network interface 505. The network interface may communicate with one or more additional wellbores, a cloud database, and with at least one remote user equipped with virtual reality equipment. The at least one remote user may be connected directly with the network interface 505, or through the cloud database.

The computer 500 also includes a signal processor 511. The signal processor 511 may perform one or more of the operations described herein. For example, the signal processor 511 may process measurement data, such as measurements obtained from multiple sensors. The processor 511 may perform inversions of the measurement data, and in some embodiments may be connected with one or more additional processors, such as in a cloud database or virtual computing machines for performing inversions of the measurement data to generate multi-dimensional physical geology representations. In response to the data collection and processing, a controller 515 may perform or control various operations and adjustments to a drilling operation. For example, the controller 515 may perform or adjust a drilling parameter of a drilling operation based on inputs received from at least one of the remote users having VR equipment.

Any one of the previously described functionalities may be partially (or entirely) implemented in hardware and/or on the processor 501. For example, the signal processor 511 may include machine-readable instructions, some of which may reside in the memory 507 and may be executed on the processor 501. The functionality described may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

The computer 500 can include other hardware or software modules. The memory 507 may be connected to the system bus 503 by a drive interface. The drives and the associated computer-readable storage devices provide non-volatile storage of computer-readable instructions, data structures, program modules and other data for the system 500. In one aspect, a hardware module that performs a particular function includes the software components shorted in a tangible computer-readable storage device in connection with the necessary hardware components, such as processor 501, bus 503, and so forth, to carry out a particular function. In the alternative, the system can use a processor and computer-readable storage device to store instructions which, when executed by the processor, cause the processor to perform operations or instructions, a method or other specific actions. The basic components and appropriate variations can be modified depending on the type of device, such as whether the computer 500 is a small, handheld computing device, a desktop computer, or a computer server, or virtual computing machine. When the processor 501 executes instructions to perform “operations”, the processor 501 can perform the operations directly and/or facilitate, direct, or cooperate with another device or component to perform the operations.

While the aspects of the disclosure are described with reference to various implementations and exploitations, it will be understood that these aspects are illustrative and that the scope of the claims is not limited to them. In general, the remote users, interactive VR equipment, cloud database, and virtual machines with processors for performing calculations, modeling, and inversions with the real time data techniques for interacting with drilling operations at one or more wellbores described herein may be implemented with facilities consistent with any hardware system or hardware systems and any software system or systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations.

In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### Example Embodiments

Aspects disclosed herein include:
Aspect A: method comprising: obtaining real time measurement data of a subsurface formation while drilling one or more wellbores into the subsurface formation; performing inversions of the measurement data to transform the measurement data into physical geology representations surrounding the one or more wellbores; communicating the measurement data and physical geology representations with two or more users, wherein the two or more users include at least one remote user equipped with virtual reality (VR) equipment configured for interactive viewing of the measurement data and geology representations in real time and interactive control of drilling operations at the one or more wellbores; receive inputs from the two or more users; and adjusting at least one drilling parameter in at least one wellbore during drilling operations in response to the inputs from at the at least one remote user.
Aspect B: A system for use with one or more wellbores, the system comprising: sensors placed downhole in the one or more wellbores and configured to obtain real time measurement data while drilling the one or more wellbores in a subsurface formation; and a control system, the control system comprising: a processor; and a computer-readable medium having instructions stored thereon that are executable by the processor, the instructions comprising, instructions to obtain the measurement data of the subsurface formation from the sensors while drilling the wellbore in the subsurface formation; instructions to perform inversions of the measurement data to transform the measurement data into three-dimensional (3D) physical geology representations of the one or more wellbores; instructions to communicate the measurement data and 3D geology representations to two or more users, wherein the two or more users include at least one remote user equipped with virtual reality (VR) equipment configured for interactive viewing of the measurement data and 3D geology representations in real time and interactive control of drilling operations at the one or more wellbores; instructions to receive inputs from the two or more users; and instructions to adjust at least one drilling parameter in at least one wellbore during drilling operations based on the inputs from the at least one remote user.
Aspect C: A wellbore control system comprising: a controller; a communication interface configured to communicate with one or more wellbores and at least one remote user, the at least one remote user equipped with virtual reality (VR) equipment; a processor; and a non-transitory computer-readable medium having instructions stored thereon that are executable by the processor, the instructions comprising: instructions to obtain real time measurement data from one or more wellbores while drilling the one or more wellbores in a subsurface formation; instructions to perform inversions of the measurement data to transform the measurement data into physical geology representations of the one or more wellbores; instructions to communicate the measurement data and geology representations to the controller operated by at least one remote user, wherein the VR equipment is configured for interactive viewing of the measurement data and geology representations in real time and interactive control of drilling operations at the one or more wellbores; instructions to receive inputs from the at least one remote user; and instructions to adjust at least one drilling parameter in at least one wellbore during drilling operations based on the inputs from the at least one remote user.

Aspects A, B, and C may have one or more of the following additional elements in combination:
Element 1: wherein adjusting at least one drilling parameter includes adjusting geosteering operations.
Element 2: wherein the geology representations are three-dimensional (3D) and the at least one remote user may interact and view the geology representations in 3D.
Element 3: wherein each of the two or more users are communicatively coupled with the one or more wellbores and with a cloud database.
Element 4: wherein the cloud database is coupled with one or more processors configured to perform calculations, modelling, or both on any adjustment of the physical geology representations or the drilling parameter, or to perform the inversions based on the modelling of the adjusted physical geology representations, the measurement data, or both.
Element 5: wherein the VR equipment is communicatively coupled with wellbore controls at the one or more wellbores and configured to direct operation of downhole tools within the one or more wellbores.
Element 6: wherein the VR equipment includes at least a viewing device, interactive controls, and a communication interface.
Element 7: wherein the viewing device includes two-dimensional (2D) or three-dimensional (3D) projection technology.
Element 8: wherein the instructions to adjust at least one drilling parameter includes instructions to adjusting geosteering operations.
Element 9: wherein the control system is communicatively coupled with each of the two or more users and a cloud database.
Element 10: wherein the instructions to perform inversions of the measurement data include instructions to communicate the measurement data to a cloud database, wherein the cloud database is coupled with one or more processors for performing inversions of the measurement data.
Element 11: wherein the control system is communicatively coupled with the VR equipment, wherein the VR equipment is configured to direct operation of downhole tools within the one or more wellbores.
Element 12: wherein the controller is communicatively coupled the at least one remote user and a cloud database.
Element 13: wherein the instructions to perform inversions of the measurement data include instructions to communicate the measurement data to a cloud database, wherein the cloud database is coupled with one or more processors for performing inversions of the measurement data.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A method comprising:
obtaining real time measurement data of a subsurface formation while drilling one or more wellbores into the subsurface formation;
performing inversions of the measurement data to transform the measurement data into physical geology representations surrounding the one or more wellbores;
communicating the measurement data and physical geology representations with two or more users, wherein the two or more users include at least one remote user equipped with virtual reality (VR) equipment configured for interactive viewing of the measurement data and geology representations in real time and interactive control of drilling operations at the one or more wellbores;
receive inputs from the two or more users; and
adjusting at least one drilling parameter in at least one wellbore during drilling operations in response to the inputs from the at least one remote user.

2. The method of claim 1, wherein adjusting at least one drilling parameter includes adjusting geosteering operations.

3. The method of claim 1, wherein the geology representations are three-dimensional (3D) and the at least one remote user may interact and view the geology representations in 3D.

4. The method of claim 1, wherein each of the two or more users are communicatively coupled with the one or more wellbores and with a cloud database.

5. The method of claim 4, wherein the cloud database is coupled with one or more processors configured to perform calculations, modelling, or both on any adjustment of the physical geology representations or the drilling parameter, or to perform the inversions based on the modelling of the adjusted physical geology representations, the measurement data, or both.

6. The method of claim 1, wherein the VR equipment is communicatively coupled with wellbore controls at the one or more wellbores and configured to direct operation of downhole tools within the one or more wellbores.

7. The method of claim 1, wherein the VR equipment includes at least a viewing device, interactive controls, and a communication interface.

8. The method of claim 7, wherein the viewing device includes two-dimensional (2D) or three-dimensional (3D) projection technology.

9. A system for use with one or more wellbores, the system comprising:
sensors placed downhole in the one or more wellbores and configured to obtain real time measurement data while drilling the one or more wellbores in a subsurface formation; and
a control system, the control system comprising:
a processor; and
a computer-readable medium having instructions stored thereon that are executable by the processor, the instructions comprising,
instructions to obtain the measurement data of the subsurface formation from the sensors while drilling the wellbore in the subsurface formation;
instructions to perform inversions of the measurement data to transform the measurement data into three-dimensional (3D) physical geology representations of the one or more wellbores;
instructions to communicate the measurement data and 3D geology representations to two or more users, wherein the two or more users include at least one remote user equipped with virtual reality (VR) equipment configured for interactive viewing of the measurement data and 3D geology representations in real time and interactive control of drilling operations at the one or more wellbores;
instructions to receive inputs from the two or more users; and
instructions to adjust at least one drilling parameter in at least one wellbore during drilling operations based on the inputs from the at least one remote user.

10. The system of claim 9, wherein the instructions to adjust at least one drilling parameter includes instructions to adjusting geosteering operations.

11. The system of claim 9, wherein the control system is communicatively coupled with each of the two or more users and a cloud database.

12. The system of claim 9, wherein the instructions to perform inversions of the measurement data include instructions to communicate the measurement data to a cloud database, wherein the cloud database is coupled with one or more processors for performing inversions of the measurement data.

13. The system of claim 12, wherein the cloud database is coupled with one or more processors configured to perform calculations, modelling, or both on any adjustment of the 3D geology representations or the drilling parameter, or to perform the inversions based on the modelling of the adjusted physical geology representations, the measurement data, or both.

14. The system of claim 9, wherein the control system is communicatively coupled with the VR equipment, wherein the VR equipment is configured to direct operation of downhole tools within the one or more wellbores.

15. The system of claim 14, wherein the VR equipment includes at least a viewing device, interactive controls, and a communication interface.

16. A wellbore control system comprising:
a controller;
a communication interface configured to communicate with one or more wellbores and at least one remote user, the at least one remote user equipped with virtual reality (VR) equipment;
a processor; and
a non-transitory computer-readable medium having instructions stored thereon that are executable by the processor, the instructions comprising:
instructions to obtain real time measurement data from one or more wellbores while drilling the one or more wellbores in a subsurface formation;
instructions to perform inversions of the measurement data to transform the measurement data into physical geology representations of the one or more wellbores;
instructions to communicate the measurement data and geology representations to the controller operated by at least one remote user, wherein the VR equipment is configured for interactive viewing of the measurement data and geology representations in real time and interactive control of drilling operations at the one or more wellbores;
instructions to receive inputs from the at least one remote user; and
instructions to adjust at least one drilling parameter in at least one wellbore during drilling operations based on the inputs from the at least one remote user.

17. The wellbore control system of claim 16, wherein the instructions to adjust at least one drilling parameter includes instructions to adjusting geosteering operations.

18. The wellbore control system of claim 16, wherein the controller is communicatively coupled the at least one remote user and a cloud database.

19. The wellbore control system of claim 16, wherein the instructions to perform inversions of the measurement data include instructions to communicate the measurement data to a cloud database, wherein the cloud database is coupled with one or more processors for performing inversions of the measurement data.

20. The wellbore control system of claim 19, wherein the cloud database is coupled with one or more processors configured to perform calculations, modelling, or both on any adjustment of the physical geology representations or the drilling parameter, or to perform the inversions based on the modelling of the adjusted physical geology representations, the measurement data, or both.
